(19) United States
(12) Patent Application Publication
(10) Pub. No.: US 2026/0160589 A1
(43) Pub. Date: Jun. 11, 2026

(54) MASS ESTIMATION APPARATUS AND METHOD

(71) Applicant: HL MANDO CORPORATION, Gyeonggi-do (KR)

(72) Inventor: Gyuwon KIM, Gyeonggi-do (KR)

(21) Appl. No.: 19/228,700

(22) Filed: Jun. 4, 2025

(30) Foreign Application Priority Data
Dec. 10, 2024 (KR) 10-2024-0182107

(51) Int. Cl. G01G 19/03

(52) U.S. Cl. CPC G01G 19/03

(57) ABSTRACT

Embodiments of the present disclosure may provide a mass estimation apparatus and method that receive motion information generated by one or more sensors, determine whether a preset condition is satisfied based on the motion information, estimate one or more parameters using a probability estimation algorithm based on the motion information in a case where the preset condition is determined to be satisfied, and estimate a mass of a vehicle using the motion information and the one or more parameters.

### CROSS-REFERENCE TO RELATED APPLICATIONS

This application claims the priority of Korean Patent Application No. 10-2024-0182107 filed on Dec. 10, 2024, in the Korean Intellectual Property Office, the disclosure of which is incorporated herein by reference.

### BACKGROUND

### Field

The present embodiments relate to a mass estimation apparatus and method.

### Description of the Related Art

A mass of a vehicle may be utilized in various control functions including braking control and active suspension control. The mass of the vehicle is a parameter closely related to a behavior of the vehicle.

In conventional control functions, the mass of the vehicle has not been considered in terms of dynamic changes such as fuel consumption, passenger presence, and cargo volume. That is, the vehicle control function has been utilized by using a static parameter identification technique based on the curb weight.

However, at this point, with the introduction of autonomous and electric vehicles, using the mass of the vehicle only as a static parameter may mean not fully utilizing the control capabilities of the vehicle.

Therefore, a method capable of real-time mass estimation is needed, but the technology is still insufficient to date.

### SUMMARY

The present embodiments may provide a mass estimation apparatus and method for estimating the mass of a vehicle in real time.

In one aspect, the present embodiments may provide a mass estimation apparatus including: a motion information receiver that receives motion information generated by one or more sensors; a condition determinator that determines whether a preset condition is satisfied based on the motion information; a parameter estimator that estimates one or more parameters using a probability estimation algorithm based on the motion information in a case where it is determined that the preset condition is satisfied; and a mass estimator that estimates a mass of a vehicle using the motion information and the one or more parameters.

In another aspect, the present embodiments may provide a mass estimation method including: receiving motion information generated by one or more sensors; determining whether a preset condition is satisfied based on the motion information; estimating one or more parameters using a probability estimation algorithm based on the motion information in a case where it is determined that the preset condition is satisfied; and estimating a mass of a vehicle using the motion information and the one or more parameters.

According to the present embodiments, a mass estimation apparatus and method for estimating the mass of a vehicle in real time can be provided.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram for explaining a mass estimation apparatus according to one embodiment;

FIG. 2 is a diagram for explaining the operation of a probability estimation algorithm according to one embodiment;

FIG. 3 is a diagram for explaining the operation of a parameter estimator according to one embodiment;

FIG. 4 is a flowchart for explaining a mass estimation method according to one embodiment; and

FIG. 5 is a block diagram for explaining a computing system of an exemplary mass estimation system.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

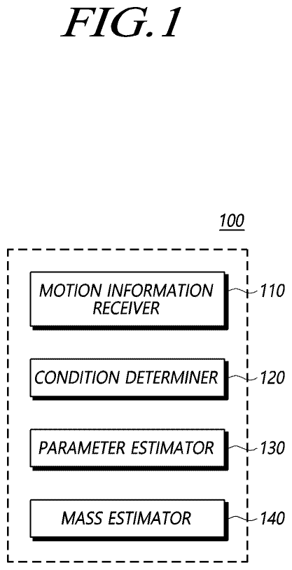

FIG. 1 is a drawing for explaining a mass estimation apparatus according to one embodiment.

A mass estimation apparatus 100 may include a motion information receiver 110 that receives motion information generated by one or more sensors, a condition determinator 120 that determines whether a preset condition is satisfied based on the motion information, a parameter estimator 130 that estimates one or more parameters using a probability estimation algorithm based on the motion information in a case where it is determined that the preset condition is satisfied, and a mass estimator 140 that estimates a mass of a vehicle using the motion information and one or more parameters.

The motion information receiver 110 may receive the motion information generated by one or more sensors.

For example, the one or more sensors may include a steering angle sensor that generates steering angle information of the vehicle, an angular velocity sensor that generates angular velocity information of the vehicle, and a gyroscope. Additionally, the one or more sensors may include a gyroscope that generates pitch angle information and rolling angle information of the vehicle. However, without being limited to the present embodiment, any sensor capable of generating the steering angle information, angular velocity information, pitch angle information, and rolling angle information may be used.

In addition, the one or more sensors may include a speed sensor capable of generating speed information of the vehicle, and an acceleration sensor capable of generating acceleration information of the vehicle. In addition, the one or more sensors may include a brake pedal position sensor that generates brake pedal displacement information. In addition, the one or more sensors may include a brake pressure sensor that generates brake pressure information. However, without being limited to the present embodiment, any sensor of generating the speed information, acceleration information, brake pedal displacement information, and brake pressure information may be used.

Additionally, one or more sensors may include a torque sensor that generates driving motor torque information. However, without being limited to the present embodiment, any sensor of generating the driving motor torque information may be used.

However, without being limited to the present embodiment, the one or more sensors may include various sensors generating various information.

For example, the motion information may include the steering angle information, angular velocity information, pitch angle information, rolling angle information, brake pedal displacement information, brake pressure information, speed information, acceleration information, and driving motor torque information.

For example, the steering angle information may include a rotation angle of a steering wheel. Additionally, the steering angle information may include a rotation angle of a wheel.

As another example, the angular velocity information may include the speed at which the vehicle rotates. Additionally, the angular velocity information may include the rotational speed at which the wheels of the vehicle rotate.

As another example, the pitch angle information may include an angle (the pitch angle) at which the vehicle rotates about a longitudinal direction (the X-axis direction) of the vehicle. As another example, the rolling angle information may include an angle (rolling angle) at which the vehicle rotates about a lateral direction (Y-axis direction) of the vehicle.

As another example, the brake pedal displacement information may include the distance the brake pedal moves in a case where the brake pedal of the vehicle is pressed. As another example, the brake pressure information may include hydraulic or air pressure generated in a case where the brake pedal of the vehicle is pressed.

As another example, the speed information may include the speed of the vehicle generated in a case where the vehicle is driving on a road. As another example, the acceleration information may include the acceleration of the vehicle generated in a case where the vehicle is driving on a road.

As another example, the driving motor torque information may include the torque value of the driving motor that generates the driving force of the vehicle. The vehicle in this case may include an electric vehicle or a hybrid vehicle.

However, without being limited to the present embodiment, various motion information may be generated. In addition, the motion information generated from one or more sensors may be transmitted to and received from an electronic control unit (ECU) of the vehicle via controller area network (CAN) communication of the vehicle.

The condition determinator 120 may determine whether the preset condition is satisfied based on the motion information.

The mass estimation apparatus 100 of the present disclosure determines whether the preset condition is satisfied through the condition determinator 120, and in a case where the preset condition is satisfied, the mass estimation apparatus 100 may perform a mass estimation operation.

For example, the preset condition may include a first condition set to determine whether the vehicle is driving in a straight line based on steering angle information and angular velocity information included in the motion information, a second condition set to determine whether the vehicle is driving on a flat surface based on pitch angle information and rolling angle information included in the motion information, and a third condition set to determine whether the vehicle is in a non-braking state based on brake pedal displacement information and brake pressure information included in the motion information.

For example, the first condition may be set to determine whether the vehicle is driving in a straight line based on the steering angle information and the angular velocity information included in the motion information.

For example, the first condition may be set to whether the steering angle information and the angular velocity information are each equal to 0.

For example, in a case where the steering angle information is 0, it may be determined that the vehicle is driving in a straight line. This is because the vehicle driving in a straight line means that the rotation angle of the steering wheel of the vehicle is close to 0. Therefore, according to the first condition, in a case where the steering angle information is 0, it may be determined that the vehicle is driving in a straight line.

As another example, in a case where the angular velocity information is 0, it may be determined that the vehicle is driving in a straight line. This is because a vehicle driving in a straight line means that the speed at which the wheels of the vehicle rotate is close to 0. Therefore, according to the first condition, in a case where the angular velocity information is 0, the vehicle may be determined to be driving in a straight line.

In addition, according to the first condition, it should be determined whether the steering angle information and the angular velocity information are each 0, and in a case where either of them is not 0, it may be determined that the first condition is not satisfied.

However, without being limited to the present embodiment, the first condition may be set to determine whether the vehicle is driving in a straight line using various motion information.

As another example, the second condition may be set to determine whether the vehicle is driving on a flat surface based on the pitch angle information and rolling angle information included in the motion information.

For example, the second condition may be set to whether the pitch angle information and the rolling angle information are each equal to 0.

For example, in a case where the pitch angle information is 0, it may be determined that the vehicle is driving on a flat surface. This is because the vehicle driving on a flat surface means that the pitch angle of the vehicle is close to 0. Therefore, according to the second condition, in a case where the pitch angle information is 0, the vehicle may be determined to be driving on a flat surface.

As another example, in a case where the rolling angle information is 0, it may be determined that the vehicle is driving on a flat surface. This is because the vehicle driving on a flat surface means that the rolling angle of the vehicle is close to 0. Therefore, according to the second condition, in a case where the rolling angle information is 0, the vehicle may be determined to be driving on a flat surface.

In addition, according to the second condition, it should be determined whether the pitch angle information and the rolling angle information are each 0, and in a case where either of them is not 0, it may be determined that the second condition is not satisfied.

However, without being limited to the present embodiment, the second condition may be set to determine whether the vehicle is driving on a flat surface using various motion information.

As another example, the third condition may be set to determine whether the vehicle is in a non-braking state based on the brake pedal displacement information and brake pressure information included in the motion information.

For example, the third condition may be set to whether the brake pedal displacement information and the brake pressure information are each equal to 0.

For example, in a case where the brake pedal displacement information is 0, the vehicle may be determined to be in a non-braking state. This is because the vehicle being in a non-braking state means that the distance the brake pedal of the vehicle has moved is close to 0. Therefore, according to the third condition, in a case where the brake pedal displacement information is 0, the vehicle may be determined to be in the non-braking state.

As another example, in a case where the brake pressure information is 0, the vehicle may be determined to be in the non-braking state. This is because the vehicle being in the non-braking state means that the hydraulic or air pressure of the brake pedal of the vehicle is close to 0. Therefore, according to the third condition, in a case where the brake pressure information is 0, the vehicle may be determined to be in the non-braking state.

In addition, according to the third condition, it should be determined whether the brake pedal displacement information and the brake pressure information are each 0, and in a case where either of them is not 0, it may be determined that the third condition is not satisfied.

However, without being limited to the present embodiment, the third condition may be set to determine whether the vehicle is in the non-braking state using various motion information.

In addition, without being limited to the present embodiment, the condition determinator 120 may include other conditions excluding the first to third conditions in the preset condition.

As another example, the condition determinator 120 may determine that the preset condition is satisfied in a case where it is determined that at least one of the first condition, the second condition, or the third condition is satisfied.

For example, the condition determinator 120 may determine that the preset condition is satisfied in a case where one of the first to third conditions is satisfied.

For another example, the condition determinator 120 may determine that the preset condition is satisfied in a case where two of the first to third conditions are satisfied.

As another example, the condition determinator 120 may determine that the preset condition is satisfied in a case where all of the first to third conditions are satisfied.

However, without being limited to the present embodiment, the condition determinator 120 may include various conditions.

In a case where it is determined that the preset condition is satisfied, the parameter estimator 130 may estimate one or more parameters using the probability estimation algorithm based on motion information.

For example, the probability estimation algorithm may estimate one or more parameters by repeatedly performing a process of receiving the speed information and driving motor torque information included in the motion information as input values, a process of transmitting a signal according to the input values from a pre-neuron to a post-neuron, and a process of generating a spike signal in a case where an action potential of the post-neuron exceeds a threshold value.

For example, the one or more of the parameters may include a rolling resistance coefficient, an aerodynamic drag coefficient, and machine efficiency information.

For example, the rolling resistance coefficient may refer to a resistance coefficient that occurs in a case where the wheels of the vehicle come into contact with a road surface. However, without being limited to the present embodiment, the rolling resistance coefficient may include various meanings.

As another example, the aerodynamic drag coefficient may refer to a coefficient related to the resistance a vehicle experiences in a case of traveling in air (fluid). However, without being limited to the present embodiment, the aerodynamic drag coefficient may include various meanings.

As another example, the machine efficiency information may be referred to as mechanical efficiency, which may mean a rate at which energy generated by the engine or drive system of a vehicle actually contributes to the movement of the vehicle. However, without being limited to the present embodiment, the machine efficiency information may include various meanings.

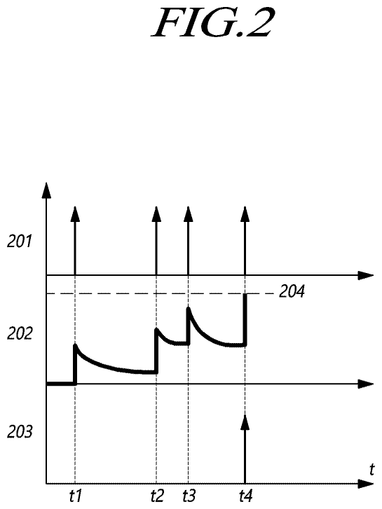

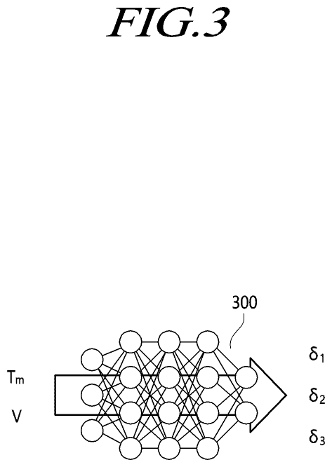

The operation of estimating one or more parameters of the parameter estimator 140 is described later with reference to FIGS. 2 and 3.

The mass estimator 140 may estimate the mass of the vehicle using the motion information and the one or more parameters.

For example, the mass estimator 140 may determine the mass of the vehicle by determining a first factor using acceleration information \dot{v} and rolling resistance coefficient cᵣᵣ+δ₂ included in the motion information, determining the second factor using turning radius information R, reduction ratio information G, driving motor torque information Tm included in the motion information, and machine efficiency information η+δ₂, and determining the third factor using vehicle frontal area information Af, speed information v included in the motion information, and aerodynamic drag coefficient information C_{d}+δ₃.

Referring to Mathematical Expression 1, the mass estimator 140 may determine the first factor using the acceleration information \dot{v}, the rolling resistance coefficient Cᵣᵣ+δ₁, and the gravitational acceleration g included in the motion information.

$$( \dot{v} + ( {C}_{rr} + {δ}_{1} ) g ) \qquad [ Mathematical Expression 1 ]$$

Referring to mathematical expression 2, the mass estimator 140 may determine the second factor using the driving motor torque information Tm, turning radius information R, and reduction ratio information G included in the motion information and the machine efficiency information η+δ₂.

$$\frac{{'}^{} {T}_{m} G ( η + {δ}_{2} )}{R} \qquad [ Mathematical Expression 2 ]$$

In this case, the turning radius information R may mean an effective rolling radius of wheel, which is the radius information of the wheel of the vehicle.

In addition, a reducer may play a role of reducing the rotation speed of the motor and amplifying the torque at the same time by using gears. In this case, the reduction ratio information G may mean the reduction gear ratio, which is the ratio at which the reducer reduces the rotation speed of the motor.

However, G and R may correspond to vehicle-specific characteristics, and G and R may be set differently depending on the vehicle.

Referring to Mathematical Expression 3, the mass estimator 140 may determine the third factor by using the vehicle frontal area information Af, the speed information v, the aerodynamic drag coefficient information C_{d}+δ₃, and an air density coefficient included in the motion information.

$$\frac{1}{2} ρ ( {C}_{d} + {δ}_{3} ) {A}_{f} {v}^{2} \qquad [ Mathematical Expression 3 ]$$

In this case, the vehicle frontal area information Af may refer to the vehicle frontal area and the cross-sectional area occupied by the front of the vehicle. However, without being limited to the present embodiment, the vehicle frontal area information may be set in various ways.

For another example, referring to Mathematical Expression 4, the mass estimator 140 may estimate the mass m of the vehicle by determining the difference between the second factor and the third factor and determining the ratio of the difference to the first factor.

$$m = \frac{1}{( \dot{v} + ( {C}_{rr} + {δ}_{1} ) g )} ( \frac{{T}_{m} G ( η + {δ}_{2} )}{R} - \frac{1}{2} ρ ( {C}_{d} + {δ}_{3} ) {A}_{f} {v}^{2} ) \qquad [ Mathematical Expression 4 ]$$

However, without being limited to the present embodiment, the mass of the vehicle may be determined in various ways.

Regarding the operation of the mass estimation apparatus described above, various embodiments will be described below with reference to the drawings. The embodiments described below may be implemented in whole or in part by each of the configurations described above. In addition, the embodiments described below may be implemented by the mass estimation apparatus by any combination.

FIG. 2 is a diagram for explaining the operation of the probability estimation algorithm according to one embodiment. FIG. 3 is a diagram for explaining the operation of the parameter estimator according to one embodiment.

Referring to FIG. 2, a horizontal axis of FIG. 2 represents time t, and the unit may be set in various ways, such as s, ms, or the like. A vertical axis of FIG. 2 may include a signal 201 according to an input value transmitted from a pre-neuron to a post-neuron, an action potential value 202 of a post-neuron, and a spike signal value 203.

The probability estimation algorithm may perform a process of receiving the speed information v and driving motor torque information Tm included in the motion information as input values.

In addition, the probability estimation algorithm may perform a process of transmitting the signal according to the input value from the pre-neuron to the post-neuron. For convenience, neurons are described by dividing them into pre-neurons and post-neurons, but the neuron is a concept that includes both the pre-neurons and post-neurons.

The probability estimation algorithm may mean an algorithm that imitates the way a neural network of animal processes information. Therefore, the probability estimation algorithm may utilize the way a signal is transmitted from neuron to neuron according to the way the neural network of animal processes information. For example, the probability estimation algorithm may perform a process of transmitting the signal from the pre-neuron to the post-neuron according to an input value at a specific time.

In addition, the signal according to the input value may mean discrete information (0 or 1). In addition, the pre-neuron may be the neuron that transmits the signal according to the input value at specific times t1 to t4, and the post-neuron may mean the neuron that receives the signal. However, without being limited to the present embodiment, various signals may be transmitted, and neurons having various definitions may be used.

Referring to FIG. 2, it may be seen that the signal according to the input value is transmitted from the pre-neuron to the post-neuron a total of four times during the period from the t1 to t4.

Additionally, the probability estimation algorithm may repeatedly perform a process of generating the spike signal in a case where the action potential 202 of the post neuron exceeds a threshold value 204.

Referring to FIG. 2, during the period from the t1 to t3, the action potential of the post neuron spikes whenever the signal according to the input value is received, and then gradually decreases over time.

At the t4, the action potential of the post neuron exceeds the threshold value 204. As the action potential of the post neuron exceeds the threshold value 204, the spike signal 203 is generated at the t4. At the same time, the action potential of the post neuron is initialized to 0. By repeatedly performing this process, one or more parameters may be estimated.

Referring to FIG. 3, the probability estimation algorithm 300 may perform a process of receiving the speed information v and driving motor torque information Tm included in the motion information as input values.

In addition, the probability estimation algorithm 300 may estimate one or more parameters as described using FIG. 2. For example, referring to FIG. 3, the one or more parameters may include δ₁, δ₂, and δ₃. In this case, δ₁, δ₂, and δ₃ may represent probability values. For another example, the one or more parameters may include the rolling resistance coefficient Cᵣᵣ+δ₁, the machine efficiency information η+δ₂, and the aerodynamic drag coefficient information C_{d}+δ₃.

However, without being limited to the present embodiment, one or more parameters may estimate various values.

In addition, the definitions, operations, and functions of the neurons (pre-neurons and post-neurons), the action potential of the post-neuron, and the spike signal used in the probability estimation algorithm may be defined and performed according to the definitions of the neurons (pre-neurons and post-neurons), the action potential of the neurons, and the definition, operation, and function of the spike signal described in Training Spiking Neural Networks Using Lessons From Deep Learning (arXiv: 2109.12894, 13, August 2023). In addition, various known definitions of the neuron, action potential of the neuron, and definition, operation, and function of the spike signal may be applied to the present disclosure.

Additionally, the probability estimation algorithm may use a spiking neural network (SNN) algorithm.

However, without being limited to the present embodiment, various probability estimation algorithms that may estimate one or more parameters may be used.

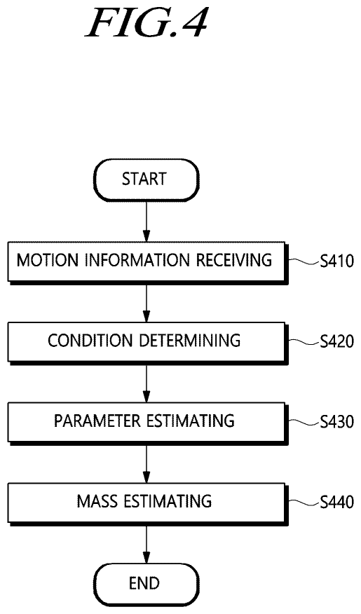

FIG. 4 is a flowchart for explaining a mass estimation method according to one embodiment.

Referring to FIG. 4, the mass estimation method may include a motion information receiving (S410) for receiving motion information generated by one or more sensors, a condition determining (S420) for determining whether a preset condition is satisfied based on the motion information, a parameter estimating (S430) for estimating one or more parameters using a probability estimation algorithm based on the motion information in a case where it is determined that the preset condition is satisfied, and a mass estimating (S440) for estimating the mass of the vehicle using the motion information and the one or more parameters.

In the motion information receiving, the motion information generated by the one or more sensors may be received (S410).

For example, the one or more sensors may include a steering angle sensor that generates steering angle information of the vehicle, an angular velocity sensor that generates angular velocity information of the vehicle, and a gyroscope. Additionally, the one or more sensors may include a gyroscope that generates pitch angle information and rolling angle information of the vehicle. However, without being limited to the present embodiment, any sensor capable of generating the steering angle information, angular velocity information, pitch angle information, and rolling angle information may be used.

In addition, the one or more sensors may include a speed sensor capable of generating speed information of the vehicle, and an acceleration sensor capable of generating acceleration information of the vehicle. In addition, the one or more sensors may include a brake pedal position sensor that generates brake pedal displacement information. In addition, the one or more sensors may include a brake pressure sensor that generates brake pressure information. However, without being limited to the present embodiment, any sensor of generating the speed information, acceleration information, brake pedal displacement information, and brake pressure information may be used.

Additionally, one or more sensors may include a torque sensor that generates driving motor torque information. However, without being limited to the present embodiment, any sensor of generating the driving motor torque information may be used.

However, without being limited to the present embodiment, the one or more sensors may include various sensors generating various information.

For example, the motion information may include the steering angle information, angular velocity information, pitch angle information, rolling angle information, brake pedal displacement information, brake pressure information, speed information, acceleration information, and driving motor torque information.

For example, the steering angle information may include a rotation angle of a steering wheel. Additionally, the steering angle information may include a rotation angle of a wheel.

As another example, the angular velocity information may include the speed at which the vehicle rotates. Additionally, the angular velocity information may include the rotational speed at which the wheels of the vehicle rotate.

As another example, the pitch angle information may include an angle (the pitch angle) at which the vehicle rotates about a longitudinal direction (the X-axis direction) of the vehicle. As another example, the rolling angle information may include an angle (rolling angle) at which the vehicle rotates about a lateral direction (Y-axis direction) of the vehicle.

As another example, the brake pedal displacement information may include the distance the brake pedal moves in a case where the brake pedal of the vehicle is pressed. As another example, the brake pressure information may include hydraulic or air pressure generated in a case where the brake pedal of the vehicle is pressed.

As another example, the speed information may include the speed of the vehicle generated in a case where the vehicle is driving on a road. As another example, the acceleration information may include the acceleration of the vehicle generated in a case where the vehicle is driving on a road.

As another example, the driving motor torque information may include the torque value of the driving motor that generates the driving force of the vehicle. The vehicle in this case may include an electric vehicle or a hybrid vehicle.

However, without being limited to the present embodiment, various motion information may be generated.

In the condition determining, whether a preset condition is satisfied may be determined based on the motion information (S420).

The mass estimation method of the present disclosure determines whether the preset condition is satisfied through the condition determining, and in a case where the preset condition is satisfied, the mass estimation method may perform a mass estimation operation.

For example, the preset condition may include a first condition set to determine whether the vehicle is driving in a straight line based on steering angle information and angular velocity information included in the motion information, a second condition set to determine whether the vehicle is driving on a flat surface based on pitch angle information and rolling angle information included in the motion information, and a third condition set to determine whether the vehicle is in a non-braking state based on the brake pedal displacement information and brake pressure information included in the motion information.

For example, the first condition may be set to determine whether the vehicle is driving in a straight line based on the steering angle information and the angular velocity information included in the motion information.

For example, the first condition may be set to whether the steering angle information and the angular velocity information are each equal to 0.

For example, in a case where the steering angle information is 0, it may be determined that the vehicle is driving in a straight line. This is because the vehicle driving in a straight line means that the rotation angle of the steering wheel of the vehicle is close to 0. Therefore, according to the first condition, in a case where the steering angle information is 0, it may be determined that the vehicle is driving in a straight line.

As another example, in a case where the angular velocity information is 0, it may be determined that the vehicle is driving in a straight line. This is because a vehicle driving in a straight line means that the speed at which the wheels of the vehicle rotate is close to 0. Therefore, according to the first condition, in a case where the angular velocity information is 0, the vehicle may be determined to be driving in a straight line.

In addition, according to the first condition, it should be determined whether the steering angle information and the angular velocity information are each 0, and in a case where either of them is not 0, it may be determined that the first condition is not satisfied.

However, without being limited to the present embodiment, the first condition may be set to determine whether the vehicle is driving in a straight line using various motion information.

As another example, the second condition may be set to determine whether the vehicle is driving on a flat surface based on the pitch angle information and rolling angle information included in the motion information.

For example, the second condition may be set to whether the pitch angle information and the rolling angle information are each equal to 0.

For example, in a case where the pitch angle information is 0, it may be determined that the vehicle is driving on a flat surface. This is because the vehicle driving on a flat surface means that the pitch angle of the vehicle is close to 0. Therefore, according to the second condition, in a case where the pitch angle information is 0, the vehicle may be determined to be driving on a flat surface.

As another example, in a case where the rolling angle information is 0, it may be determined that the vehicle is driving on a flat surface. This is because the vehicle driving on a flat surface means that the rolling angle of the vehicle is close to 0. Therefore, according to the second condition, in a case where the rolling angle information is 0, the vehicle may be determined to be driving on a flat surface.

In addition, according to the second condition, it should be determined whether the pitch angle information and the rolling angle information are each 0, and in a case where either of them is not 0, it may be determined that the second condition is not satisfied.

However, without being limited to the present embodiment, the second condition may be set to determine whether the vehicle is driving on a flat surface using various motion information.

As another example, the third condition may be set to determine whether the vehicle is in a non-braking state based on the brake pedal displacement information and brake pressure information included in the motion information.

For example, the third condition may be set to whether the brake pedal displacement information and the brake pressure information are each equal to 0.

For example, in a case where the brake pedal displacement information is 0, the vehicle may be determined to be in a non-braking state. This is because the vehicle being in a non-braking state means that the distance the brake pedal of the vehicle has moved is close to 0. Therefore, according to the third condition, in a case where the brake pedal displacement information is 0, the vehicle may be determined to be in the non-braking state.

As another example, in a case where the brake pressure information is 0, the vehicle may be determined to be in the non-braking state. This is because the vehicle being in the non-braking state means that the hydraulic or air pressure of the brake pedal of the vehicle is close to 0. Therefore, according to the third condition, in a case where the brake pressure information is 0, the vehicle may be determined to be in the non-braking state.

In addition, according to the third condition, it should be determined whether the brake pedal displacement information and the brake pressure information are each 0, and in a case where either of them is not 0, it may be determined that the third condition is not satisfied.

However, without being limited to the present embodiment, the third condition may be set to determine whether the vehicle is in the non-braking state using various motion information.

In addition, without being limited to the present embodiment, the condition determining may include other conditions excluding the first to third conditions in the preset condition.

As another example, the condition determining may determine that the preset condition is satisfied in a case where it is determined that at least one of the first condition, the second condition, or the third condition is satisfied.

For example, the condition determining may determine that the preset condition is satisfied in a case where one of the first to third conditions is satisfied.

For another example, the condition determining may determine that the preset condition is satisfied in a case where two of the first to third conditions are satisfied.

As another example, the condition determining may determine that a preset condition is satisfied in a case where all of the first to third conditions are satisfied.

However, without being limited to the present embodiment, the condition determining may include various conditions.

In the parameter estimating, in a case where it is determined that the preset condition is satisfied, one or more parameters may be estimated using the probability estimation algorithm based on the motion information (S430).

For example, the probability estimation algorithm may estimate one or more parameters by repeatedly performing a process of receiving the speed information and driving motor torque information included in the motion information as input values, a process of transmitting a signal according to the input values from a pre-neuron to a post-neuron, and a process of generating a spike signal in a case where an action potential of the post-neuron exceeds a threshold value.

For example, the one or more of the parameters may include a rolling resistance coefficient, an aerodynamic drag coefficient, and machine efficiency information.

For example, the rolling resistance coefficient may refer to a resistance coefficient that occurs in a case where the wheels of the vehicle come into contact with a road surface. However, without being limited to the present embodiment, the rolling resistance coefficient may include various meanings.

As another example, the aerodynamic drag coefficient may refer to a coefficient related to the resistance a vehicle experiences in a case of traveling in air (fluid). However, without being limited to the present embodiment, the aerodynamic drag coefficient may include various meanings.

As another example, the machine efficiency information may be referred to as mechanical efficiency, which may mean the rate at which energy generated by the engine or drive system of a vehicle actually contributes to the movement of the vehicle. However, without being limited to the present embodiment, the machine efficiency information may include various meanings.

In the mass estimating, the mass of the vehicle may be estimated using the motion information and one or more parameters (S440).

For example, in the mass estimating, the mass of the vehicle may be determined by determining a first factor using acceleration information \dot{v} and rolling resistance coefficient Cᵣᵣ+δ₁ included in the motion information, determining the second factor using turning radius information R, reduction ratio information G, driving motor torque information Tm included in the motion information, and machine efficiency information η+δ₂, and determining the third factor using vehicle frontal area information Af, speed information v included in the motion information, and aerodynamic drag coefficient information C_{d}+δ₃.

In the mass estimating, the first factor may be determined using the acceleration information \dot{v}, the rolling resistance coefficient Cᵣᵣ+δ₁, and the gravitational acceleration g included in the motion information.

In the mass estimating, the second factor may be determined using the driving motor torque information Tm, turning radius information R, and reduction ratio information G included in the motion information and the machine efficiency information η+δ₂.

In this case, the turning radius information R may mean an effective rolling radius of wheel, which is the radius information of the wheel of the vehicle.

In addition, a reducer may play a role of reducing the rotation speed of the motor and amplifying the torque at the same time by using gears. In this case, the reduction ratio information G may mean the reduction gear ratio, which is the ratio at which the reducer reduces the rotation speed of the motor.

However, G and R may correspond to vehicle-specific characteristics, and G, η, and R may be set differently depending on the vehicle.

In the mass estimating, the third factor may be determined by using the vehicle frontal area information Af, the speed information v, the aerodynamic drag coefficient information C_{d}+δ₃, and an air density coefficient included in the motion information.

In this case, the vehicle frontal area information Af may refer to the vehicle frontal area and the cross-sectional area occupied by the front of the vehicle. However, without being limited to the present embodiment, the vehicle frontal area information may be set in various ways.

As another example, in the mass estimating, the mass m of the vehicle may be estimated by determining the difference between the second factor and the third factor and determining the ratio of the difference to the first factor.

However, without being limited to the present embodiment, the mass of the vehicle may be determined in various ways.

Meanwhile, the present disclosure may include a mass estimation system for implementing the above-described device and/or method. For example, the mass estimation system may be implemented as a computing system.

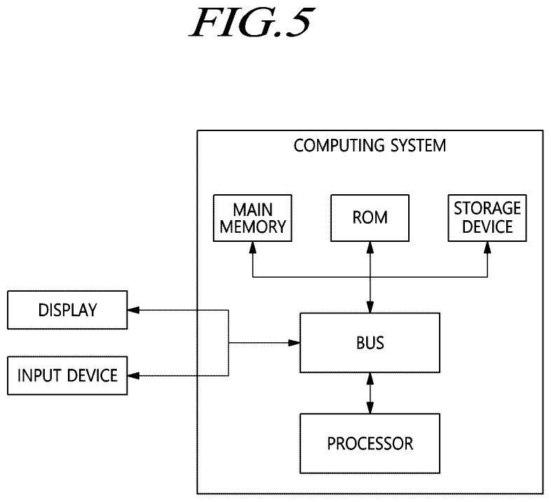

FIG. 5 is a block diagram illustrating a computing system of an exemplary mass estimation system.

Referring to FIG. 5, a computing system for estimating the mass of a vehicle may include at least one processor for executing computer-readable instructions contained in a memory. Here, the at least one processor may determine whether a preset condition is satisfied based on motion information in a case of receiving the motion information generated by one or more sensors, estimate one or more parameters using a probability estimation algorithm based on the motion information in a case where it is determined that the preset condition is satisfied, and process a process of estimating the mass of the vehicle using the motion information and the one or more parameters.

For example, the probability estimation algorithm may estimate one or more parameters by repeatedly performing a process of receiving the speed information and driving motor torque information included in the motion information as input values, a process of transmitting a signal according to the input values from a pre-neuron to a post-neuron, and a process of generating a spike signal in a case where an action potential of the post-neuron exceeds a threshold value.

Additionally, the one or more parameters may include the rolling resistance coefficient, the aerodynamic drag coefficient, and the machine efficiency information.

The at least one processor may the mass of the vehicle by determining a first factor using the acceleration information and the rolling resistance coefficient included in the motion information, determining a second factor using turning radius information, reduction ratio information, driving motor torque information included in the motion information, and the machine efficiency information, and determining a third factor using vehicle frontal area information, the speed information included in the motion information, and the aerodynamic drag coefficient to estimate the mass of the vehicle.

In addition, the computing system may further include ROM, a storage device, or the like, and may transmit and receive information with the processor and an external display and an input device through a bus.

The aforementioned memory may be interpreted to mean a main memory, ROM, and a storage device. The computing system may be configured in a vehicle or may be configured as an external device such as a server.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, for example, an FPGA (field-programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (for example, components of the data processing system) to perform actions by operating on input data and generating output. The processes and logic flows can also be performed by, and apparatuses can also be implemented as, special purpose logic circuitry, for example, an FPGA (field-programmable gate array) or an ASIC (application-specific integrated circuit). Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto optical disks; and CD ROM and DVD-ROM disks. The processor and the memory can be supplemented by, or incorporated in, special purpose logic circuitry.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded the widest scope consistent with the claims.

What is claimed is:

1. A mass estimation apparatus comprising:
a motion information receiver that receives motion information generated by one or more sensors;
a condition determinator that determines whether a preset condition is satisfied based on the motion information;
a parameter estimator that estimates one or more parameters using a probability estimation algorithm based on the motion information in a case where it is determined that the preset condition is satisfied; and
a mass estimator that estimates a mass of a vehicle using the motion information and the one or more parameters.

2. The mass estimation apparatus of claim 1, wherein the motion information includes steering angle information, angular velocity information, pitch angle information, rolling angle information, brake pedal displacement information, brake pressure information, speed information, acceleration information, and driving motor torque information.

3. The mass estimation apparatus of claim 1, wherein the preset condition includes a first condition set to determine whether the vehicle is driving in a straight line based on steering angle information and angular velocity information included in the motion information, a second condition set to determine whether the vehicle is driving on a flat surface based on pitch angle information and rolling angle information included in the motion information, and a third condition set to determine whether the vehicle is in a non-braking state based on brake pedal displacement information and brake pressure information included in the motion information.

4. The mass estimation apparatus of claim 3, wherein the condition determinator determines that the preset condition is satisfied in a case where it is determined that at least one of the first condition, the second condition, or the third condition is satisfied.

5. The mass estimation apparatus of claim 1, wherein the probability estimation algorithm estimates one or more parameters by repeatedly performing a process of receiving speed information and driving motor torque information included in the motion information as input values, a process of transmitting a signal according to the input values from a pre-neuron to a post-neuron, and a process of generating a spike signal in a case where an action potential of the post-neuron exceeds a threshold value.

6. The mass estimation apparatus of claim 1, wherein the one or more parameters include a rolling resistance coefficient, an aerodynamic drag coefficient, and machine efficiency information.

7. The mass estimation apparatus of claim 6, wherein the mass estimator estimates the mass of the vehicle by
determining a first factor using the acceleration information and the rolling resistance coefficient included in the motion information,
determining a second factor using turning radius information, reduction ratio information, driving motor torque information included in the motion information, and the machine efficiency information, and
determining a third factor using vehicle frontal area information, the speed information included in the motion information, and the aerodynamic drag coefficient to estimate the mass of the vehicle.

8. The mass estimation apparatus of claim 7, wherein the mass estimator determines a difference between the second factor and the third factor, and
determines a ratio of the difference to the first factor to estimate the mass of the vehicle.

9. A mass estimation method comprising:
receiving motion information generated by one or more sensors;
determining whether a preset condition is satisfied based on the motion information;
estimating one or more parameters using a probability estimation algorithm based on the motion information in a case where it is determined that the preset condition is satisfied; and
estimating a mass of a vehicle using the motion information and the one or more parameters.

10. The mass estimation method of claim 9, wherein the motion information includes steering angle information, angular velocity information, pitch angle information, rolling angle information, brake pedal displacement information, brake pressure information, speed information, acceleration information, and driving motor torque information.

11. The mass estimation method of claim 9, wherein the preset condition includes a first condition set to determine whether the vehicle is driving in a straight line based on steering angle information and angular velocity information included in the motion information, a second condition set to determine whether the vehicle is driving on a flat surface based on pitch angle information and rolling angle information included in the motion information, and a third condition set to determine whether the vehicle is in a non-braking state based on brake pedal displacement information and brake pressure information included in the motion information.

12. The mass estimation method of claim 11, wherein in the determining of the condition, it is determined that the preset condition is satisfied in a case where it is determined that at least one of the first condition, the second condition, or the third condition is satisfied.

13. The mass estimation method of claim 9, wherein the probability estimation algorithm estimates one or more parameters by repeatedly performing a process of receiving speed information and driving motor torque information included in the motion information as input values, a process of transmitting a signal according to the input values from a pre-neuron to a post-neuron, and a process of generating a spike signal in a case where an action potential of the post-neuron exceeds a threshold value.

14. The mass estimation method of claim 9, wherein the one or more parameters include a rolling resistance coefficient, an aerodynamic drag coefficient, and machine efficiency information.

15. The mass estimation method of claim 14, wherein in the estimating of the mass,
a first factor is determined using the acceleration information and the rolling resistance coefficient included in the motion information,
a second factor is determined using turning radius information, reduction ratio information, driving motor torque information included in the motion information, and the machine efficiency information, and
a third factor is determined using vehicle frontal area information, the speed information included in the motion information, and the aerodynamic drag coefficient to estimate the mass of the vehicle.

16. The mass estimation method of claim 15, wherein in the estimating of the mass,
a difference between the second factor and the third factor is determined, and
a ratio of the difference to the first factor is determined to estimate the mass of the vehicle.

17. A computing system for estimating a mass of a vehicle, the computing system comprising:
at least one processor for executing computer-readable instructions contained in a memory;
wherein the at least one processor;
determines whether a preset condition is satisfied based on motion information in a case of receiving the motion information generated by one or more sensors;
estimates one or more parameters using a probability estimation algorithm based on the motion information in a case where it is determined that the preset condition is satisfied; and
processes a process of estimating the mass of the vehicle using the motion information and the one or more parameters.

18. The computing system of claim 17, wherein the probability estimation algorithm estimates one or more parameters by repeatedly performing a process of receiving speed information and driving motor torque information included in the motion information as input values, a process of transmitting a signal according to the input values from a pre-neuron to a post-neuron, and a process of generating a spike signal in a case where an action potential of the post-neuron exceeds a threshold value.

19. The computing system of claim 17, wherein the one or more parameters include a rolling resistance coefficient, an aerodynamic drag coefficient, and machine efficiency information.

20. The computing system of claim 19, wherein the at least one processor the mass of the vehicle by
determining a first factor using the acceleration information and the rolling resistance coefficient included in the motion information,
determining a second factor using turning radius information, reduction ratio information, driving motor torque information included in the motion information, and the machine efficiency information, and
determining a third factor using vehicle frontal area information, the speed information included in the motion information, and the aerodynamic drag coefficient to estimate the mass of the vehicle.
